(19) United States
(12) Patent Application Publication
(10) Pub. No.: US 2010/0032178 A1
(43) Pub. Date: Feb. 11, 2010

(54) PROCEDURE FOR OPERATING A MACHINE TOOL AND MACHINE TOOL FOR THIS PURPOSE

(75) Inventors: Thilo Koeder, Gerlingen (DE); Joachim Platzer, Remseck-Hochberg (DE); Ulli Hoffmann, Niefern-Oeschelbronn (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 12/536,130

(22) Filed: Aug. 5, 2009

(30) Foreign Application Priority Data
Aug. 7, 2008 (DE) 10 2008 041 088.8

(51) Int. Cl. B23Q 17/22; B23Q 9/00; B23D 49/16

(52) U.S. Cl. 173/1; 173/2; 30/376

(57) ABSTRACT

A machine tool, in particular in a handheld configuration, that is equipped with tools for a sensory detection of a trajectory that serves as a guideline and is detected in characteristic values and read in, alternatively to a programmed trajectory. The characteristic values that are on a side of the machine tool are converted into control signals for a working line that is tracked mark-free.

This application claims benefit of Ser. No. 10 2008 041 088.8, filed Aug. 7, 2008 in Germany and which application is incorporated herein by reference. To the extent appropriate, a claim of priority is made to the above disclosed applications.

### TECHNICAL FIELD

The invention concerns a procedure for operating a machine tool, in particular a handheld machine tool, with devices for a sensory detection of reference characteristics that are on the side of the work piece and for an arithmetical conversion of characteristic values that correspond with these characteristics into control signals, which serve for a guidance of the machine tool across from a corresponding work piece. The invention furthermore concerns also a machine tool that has to be operated according to the procedure.

### BACKGROUND

At machine tool, in particular handheld machine tools, which work for a material removal, especially jig- or circular saws as well as finger rotary cultivators, the view of the user is often restricted to the field of work or the working tool that is on the side of the work piece—and marks that might be there—due to handling, construction type and/or function. That complicates the working and can also impair the working results. Therefore it is often worked with auxiliary devices, thus for example with illuminating devices in order to improve the visibility at least in the immediate field of work. Furthermore also with observing devices that shall enable an indirect observation of the field of work.

For such machine tools it is also worked with auxiliary devices, which should make the tracking of a desired working line easier, even if it is can only be seen insufficiently due to dirt or due to the covering of the machine tool. Thereby the guidance of the machine tool takes place along a trajectory as guideline that is parallel to the desired working line and shifted sideways. A guide shoe, which is overhanging sideways to the machine tool and which is arranged and applied at an adjustable radial-arm that is opposed to the machine tool and which can be shifted along the guideline serves as an auxiliary device.

By adjusting the guide shoe across from the machine tool, thus by changing the distance that has been bridged over the radial-arm between the guide shoe and the machine tool, parallel working lines that are located shifted to a guideline can be driven. But this is always connected with a corresponding adjustment work.

### SUMMARY

The invention is based on the task to create better possibilities of guidance of a machine tool on a desired working line for the user, which follows a guideline, as well as depending on the configuration of the machine tool if necessary to support the user also in its guidance of the machine tool that is oriented by the guideline on such a working line.

One aspect of the invention relates to a trajectory that is preset for the machine tool on the side of the work piece. The trajectory is detected by its characteristic values and is read in on the side of the machine. By the control signals for the working tool that correspond with these characteristic values, a working line that has to be driven and that corresponds with the read-in trajectory is provided mark-free.

The tools, which serve the sensory detection of the reference characteristics that are on the surface and describe the trajectory, are hereby not used to read in the trajectory, but moreover also for the orientation of the machine tool towards characteristics that are on the side of the work piece when driving along the working line that is provided arithmetically and that corresponds with the read-in trajectory. Thereby the procedure according to the invention can be implemented at least without an additional significant effort on the side of the machine, but simultaneously track a once read-in thus detected trajectory several times, without additional adjustment works, because a noticeable illustration of the working line, for example by marks, is not necessary.

The same applies basically also when a trajectory serves as a guideline that is not driven along and read-in with the aid of a trajectory on the side of the work piece, but instead is provided programmed, whereby it is in the range of the invention to configure the machine tool in such a way that it can be work on the basis of a trajectory that is either read in or programmed.

When reading in the trajectory that creates the guideline it is detected at least in the course and direction towards the work piece, if the user should only be supported passively when driving along a corresponding working line, namely by corresponding hints as for example signal-beams and/or display illustrations of the corresponding section of the working line that has to be driven along and/or direction hints. Such hints can also be the displaying of the nominal direction and deviations hereto in color.

If the user is actively supported at the guiding of the machine tool in particular at so-called semi-automatic systems, thus especially by an orientation of the working tool of the machine tool towards the working line that has to be driven along by a corresponding changing of the rotational position towards the machine tool, a trajectory that has been read in is not only detected according to its course and orientation, but moreover also the rotational position of the tool to the machine tool—corresponding hereto—is provided. The same applies also with regard to trajectories that are programmed.

The sensory tools for detecting a trajectory that serves as a guideline as well as for guiding the machine tool along a mark-free working line that has to be driven along, each oriented at reference characteristics on the side of the work piece, are usefully created by so-called speed-over-ground or mouse sensors, which allow to detect the speed, the orientation of the machine and the type of track, thus its straight or cricket course.

Independent of the guiding of the machine tool only by the user or semi-autonomously, thus at only direction oriented supporting of the machine tool by the user, the danger exists in particular at irregularities in the structure of the work piece and/or working lines with narrow curve radii, that with regard to an advance speed the working speed of the tool is big and that the tool gets therefore too hot, so that the work piece “burns out” in the area of the processing position while sawing at the sawing position. In order to face that an adaptive adjustment of the working speed of the tool to the advance speed is provided according to the invention for example by changing the number of strokes or the rotational speed.

At machine tools, in particular at handheld machine tools such as jig or circular saws, it is generally a problem to meet the starting point on the side of the work piece for a desired working line that has to be driven along and additionally to orient the machine tool or the tool according to the direction of the course of the working line based on the starting point, in order to achieve a waste-free operation. This is particularly important if a trajectory is provided for the machine tool that is read in or programmed and based on that a working line has to be driven along mark-free, for whose position and orientation towards the work piece the position and orientation in the starting point is absolutely determining.

With regard to this determination a detection of the reference characteristics on the side of the work piece in the area of the starting point to the work piece is provided according to the invention and furthermore the position of the machine tool to the work piece with regard to a reference position that is given by the reference characteristics is determined. This reference position is detected in its position to the working line that has to be driven along, so that by a display of the deviation a corresponding alternating orientation can takes place by the user or analogously on the side of the machine tool by an orienting control of the working tool.

By such an orientation it is achieved and established that by reading in or programming preset trajectories can be exactly tracked as working lines not only in its alignment, but also in a desired position and/or orientation towards each other if necessary, so for example with a course that is parallel to each other; all this in a user-guided as well as only user-supported semi-autonomous operation of the machine tool.

Such a procedure according to the invention is also useful at a guidance of a tool that only takes place on the side of the user along a working line that has to be tracked by default marks based on its starting point, but especially when such a working line is provided mark-free on the part of the machine tool, be it by reading in or programming, because in a semi-autonomous operation ultimately there are barely any correction possibilities on the part of the user by changing his guiding behavior.

The invention furthermore concerns a machine tool, in particular a handheld machine tool, which enables a previously described procedure and which provides a working area for a working tool, which has to be positioned at a work piece. Furthermore with tools for a sensory detection of reference characteristics on the side of the work piece that are given in the area of the working tool, whereby a arithmetic and control unit for processing the sensory detected reference characteristics as well as for converting them into characteristic values and for adjusting with characteristics values is provided, which describe a default trajectory. By control signals that correspond with these characteristic values the orientation of the machine tool and/or the working tool towards a virtual working line that corresponds with the trajectory and that has to be tracked on the side of the work piece is carried out, and/or hints for guiding the machine tool on this working line are controlled for the user. This takes for example place in the form of display illustrations, or by orienting corresponding signal-aids, in particular optical signals-aids in the form of signals-beams.

The tools that serve for the sensory detection of reference characteristics are created as optical tools in particular by sensors, especially mouse sensors, which are arranged in working direction upstream to the working tool and pointed at the work piece. Instead of such mouse sensors, by which the rotational direction of the machine tool, its advance speed as well as the course of the working line as a straight or curve can be detected, also mechanical sensors, such as friction wheels, friction rolls or balls can be used. The latter in particular in connection with sensors that are construed in the form of a camera, by which information can be won that corresponds by a picture comparison, that has to be processed by the arithmetic and control unit and that has to be converted into characteristic values as well as control signals.

Particularly advantageous is the operation of the machine tool according to the invention in the form of jigsaws with an adjustable saw blade that is driven stroke-movably and that can be rotated around its longitudinal axis, whose rotational position is oriented at the corresponding working line by an actuator that belongs to the control and arithmetic unit.

### BRIEF DESCRIPTION OF THE DRAWINGS

Further details and characteristics of the invention arise from the claims. Furthermore the invention is explained in the following with the aid of an embodiment.

It is shown:

FIG. 1 is a jigsaw in a perspective illustration as an example for a machine tool according to the invention, which provides a saw blade being a jig saw, which has to be operated semi-autonomously and which can be rotated around its longitudinal axis and adjusted in its rotational position by an actuator, and which meshes into a work piece in the illustration, on which the jig saw is positioned,

FIG. 2 is a schematized illustration of a top view on the working area of the base plate of the jig saw that has been infiltrated by the saw blade at the indication of a working line for the saw blade, and

FIG. 3 is an illustration that is similar to FIG. 2, in which the base plate of the machine tool is illustrated while approaching a work piece, for explaining the positioning of the machine tool at a work piece with an orientation towards a working line, which has to be driven along the work piece and which is based on a starting point for the tool.

### DETAILED DESCRIPTION

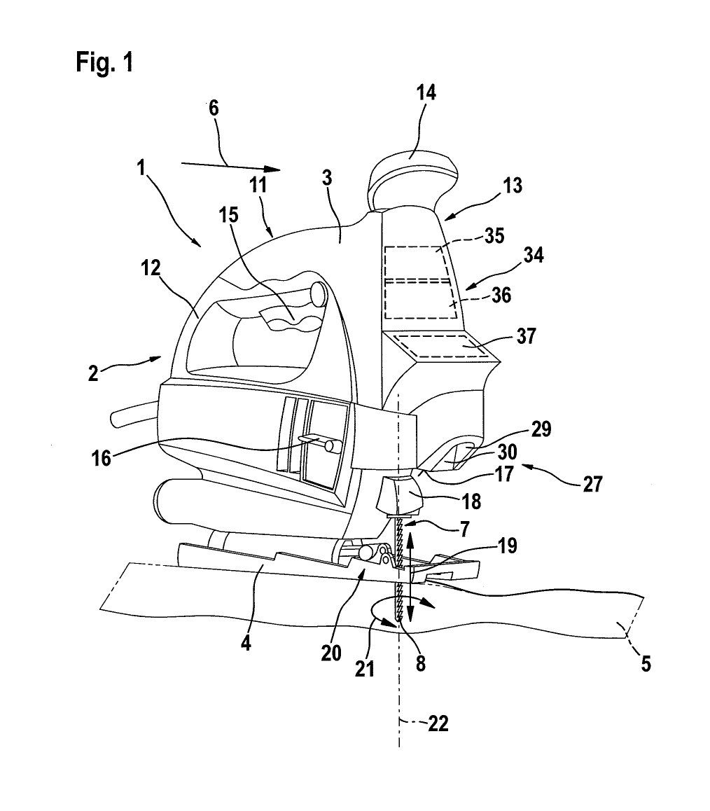

FIG. 1 illustrates a handheld machine tool 1 in the form of a jigsaw 2, which provides a housing 3 and which is adjustably supported by a base plate 4 on a work piece 5. In working direction 6 in the front area of the jigsaw 2 it provides a saw blade 8 as a working tool 7. It meshes in working operation into the work piece 5.

The jigsaw 2 provides furthermore a field of vision 10 on the side of the user, which spreads at least over the range of the working area 9 that is determined by the saw blade 8, and as illustrated, which reaches out over it in working direction 6, in order to provide the user with an optimal overview over the working conditions. The working area 9 and the field of vision 10 are illustrated as section that is provided in the base plate 4, so that with regard to the working tool 7 corresponding with the size of the field of vision 10 a significant protrusion of the base plate 4 beyond the saw blade 8 results.

The housing 3 of the jigsaw 2 provides a strap-like handle 11 in upwards direction opposed to the base plate 4 that is supported noticeably and that goes around a swiveling axis in working direction 6, whose grip handle 12 spans in working direction 6 and arrives in the front at the front wall area 13 of the housing 3. Upwards it merges into a guide knob 14. In the area of the handle 11 a switch arrangement 15 is provided gripping under the grip handle 12, by which the machine tool 1 can be switched on and off. Different operating modes of the jigsaw 2 can be adjusted over the switching device 16 that is provided on the longitudinal side of the housing 3.

The front wall area 13 of the housing 3 is layered offset contrary to the working direction 6 and running downwards in the direction of the base plate 4. The thereby originating step 17 covers the tool entrance 18 for the saw blade 8, which is driven stroke-movably according to the embodiment of the machine tool 1 as an electrically operated machine and in the direction of the arrow 19.

A first operating mode is the regulation work operation, at which the saw blade 8 that is pointed torque-proof in working direction 6 is operated only in direction of stroke (arrow 19).

A further operating mode is the so-called pendulum stroke operation, at which the saw blade 8 that is overlaid to the stroke movement in the direction of the arrow 19 can be swiveled around a not shown swivel axis that runs transversely to the saw blade level. The actuator 20 that is provided for this purpose is partially illustrated.

In a third operating mode, illustrated by the arrow 21, the saw blade 8 can be swiveled in addition to the stroke movement (arrow 19) around a rotational axis 22 that runs in the direction of its longitudinal axis. The saw blade 8 can thereby be adjusted from its straight position, corresponding with a zero angle to the longitudinal axis 25 of the jigsaw 2, into working directions that are angled to the longitudinal axis 25. The jigsaw 2 can thereby be used as so-called scrolling jigsaw and can be operated at a correspondingly controlled adjustment as semi-autonomous jigsaw 2. That means, that the user that is holding the jigsaw 2 basically takes over only the advance that is roughly pointed at the corresponding working direction 6, and supports reaction forces that result from the working operation, but that the exact positioning of the jigsaw 2 that is pointed at a working line 24 and corresponding with it takes place by a rotational adjustment of the saw blade 8.

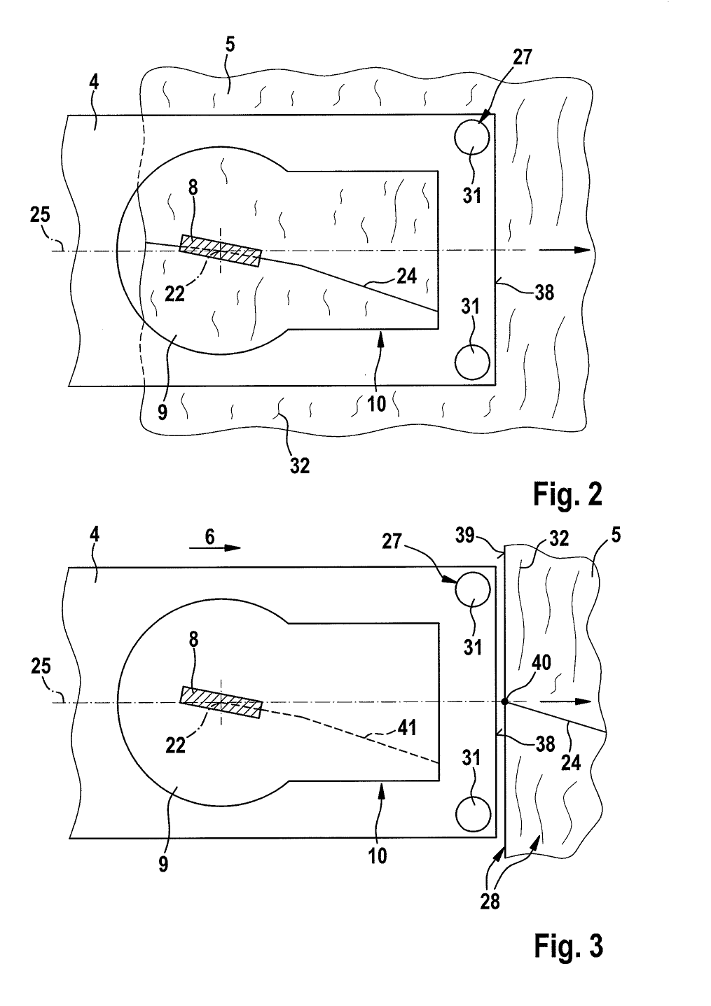

The jigsaw 2 is furthermore provided with tools 27 for a sensory detection of reference characteristics 28 on the side of the work piece, as they are shown in FIG. 2 and 3 as characteristics that can be optically noticed at the work piece 5, for example in the form of grains 32 or even work piece edges 39. A camera 29 is indicated as a tool 27 for the sensory detection in the transition that is created by step 17, but the corresponding area qualifies also for other sensor arrangements, as in particular line sensors. It is furthermore preferred to provide an illuminating arrangement 30 or also a signal-beamer as an advantage, if desired, the illuminating arrangement for improving the viewing conditions in the working area 9 and/or in the field of vision 10, the signal-beamer as an optical orientation aid for a user in the direction of the machine tool 1 towards a working line 24.

Further tools 27 for the sensory detection of reference characteristics 28 on the side of the work piece are mouse sensors 31 that are arranged on the front side of the base plate 4 on both sides of the longitudinal axis 25.

It is furthermore schematically indicated in FIG. 1 that the machine tool 1 is equipped with control tools 34, thus in particular with an arithmetic unit 35 and a control unit 36, preferred with a subordinate adjusting unit, which comprises an actuator for adjusting the rotational position of the saw blade 8. A furthermore provided display field 37 serves in particular for providing the user with hints for the guidance of the machine tool, but can also be used for warning notices and such alike. The display field 37 is arranged in the front wall area 13, preferably above step 17 and overhanging in the opposite direction to it, so that is located in the immediate field of vision of the user.

According to the invention the tools 27 for the sensory detection are partially used under different aspects, thus for detecting a trajectory 41 (FIG. 3) that is tracked by the machine tool 1 at a work piece on the one hand, and corresponding with that, for orienting by detecting characteristics on the side of the work piece as reference characteristics (28) on the other hand, if a desired, unmarked working line 24 that is on the side of the work piece shall be driven along, which corresponds with the read-in trajectory 41.

If it is worked with a camera 29 the required movement data can be determined by an image comparison, if it is worked with mouse sensors 31 the corresponding movement data results from the detected reference characteristics of the work piece surface, thus for example grains 32 or edges 39.

Instead of the detection of a tracked trajectory and its storage, in order to be able to use it subsequently as guideline for a working line 24 that has to be driven along, the guideline of corresponding movement data for a working line 24 that has to be driven along can also take place by an arithmetical way and be provided programmed.

With the tools 27 for a sensory detection the position of a machine tool 1, in particular a jigsaw 2 to a work piece 5, at which the jigsaw 2 should be positioned, can also be detected, as it is indicated in FIG. 3. FIG. 3 illustrates this situation and due to simplicity reasons only the base plate 4 of the jigsaw 2 is shown in an illustration that is analogous to FIG. 2, positioned opposed to the work piece 5, so that the base plate 4 is initially positioned with its front side 38 contrary to the edge 39 of the work piece 5. If the jigsaw 2 moves along in working direction 6, the base plate 4 runs towards the work piece 5 and thus the edge 39 and subsequently also other reference characteristics—such as the grain 31—into the observation area of the sensory tools 27, in particular the mouse sensors 31 at first. But a corresponding detection is also possible by a camera 29.

Thereby a defined orientation of the jigsaw 2 to the work piece 5 oriented at reference characteristics 28 is possible, may it for example be an edge 39 and/or a grain 32, and corresponding with this orientation also the driving along a working line 24, which is equivalent to a read in or programmed trajectory 41 and which is based on a starting point 40 on the side of the work piece, which almost corresponds on the side of the machine as initial point of the trajectory 41 with the rotational axis 22 of the saw blade 5. Such a trajectory 41 is for example indicated by dotted lines in FIG. 3, the corresponding working line 24 on the side of the work piece on the other side by a solid line, despite of the fact that the working line 24 is not provided as a mark at the work piece 5. The illustration in FIG. 3 is based on a reference line that is provided by the edge 39, to which the jigsaw 2 is positioned vertically with its longitudinal axis 25. Also this orientation towards the edge 39 as reference line, or to another corresponding reference line, is usefully illustrated for the user for example in the display field 37 when positioning the saw blade 8 in the starting point 40.

If the jigsaw 2 is lead towards the work piece 5 by the user, usually only a rough orientation of the jigsaw 2 towards the desired working direction as well as towards the correspondingly desired or also provided, for example marked starting point 40, is provided. As soon as the work piece 5 is almost reached by this means and it is located in the detection area of the sensory tools 27, deviations to the orientation towards the starting point 40 are usefully illustrated in the display field 37 and corresponding direction hints are provided. The same applies preferably also for the orientation of the jigsaw 2 towards the reference line. It is particularly advantageous to signalize a correct allocation, if necessary to activate the jigsaw 2 not until a correct allocation.

A targeted approaching of the starting point 40 with the saw blade 8 of the jigsaw 2 is thereby at least basically possible, and therefore also based on the starting point 40 a working that this oriented along the starting line 24 is ensured, especially because a small offset, which can be compensated by an angular positioning of the saw blade 8 in the starting point 40, can subsequently be balanced by rotating the saw blade 8 and the initially present offset has practically no effect on the cross section, because it is notched in the starting point 40 and based on that an orientation of the saw blade 8 towards the working line 24 takes place.

With the procedure according to the invention, which reliably enables the driving along a working line 24 guided by a user or semi-autonomous based on a corresponding starting point 40, good work results can be achieved in a user guided as well as semi-autonomous operating. User guided at a not rotating saw blade 8, or at most at a manually rotating saw blade 8, for example by the guide knob 14 due to the guiding hints for example in the display field 37, in semi-autonomous operation due to the guidance by the saw blade 8 at a supporting and advancing on the side of the user perhaps in the direction of the working line 24, thus at an appropriate handling of the machine tool 1 by the user.

In particular at a rotating saw blade 8, and thus in a semi-autonomous operation, also relatively narrow radii can be sawed, whereby the danger increases that the user does not take this into account in his supporting of the jigsaw 2 or in the orientation of his advance force and/or advance speed that is oriented towards the jigsaw 2. In order to prevent damages at the work piece 5 and/or at the tool in such cases, in particular the saw blade 8, it proves to be useful if an adaptive adjustment of the working speed of the tool towards the advance speed takes place, and this in particular under consideration of the corresponding course of the working line 24. The adjustment of the working speed is usefully undertaken by changing the number of strokes of the saw blade 8.

1. A method of operating a handheld machine tool comprising a sensory tool for a sensory detection of a reference characteristic that describes a default trajectory on a side of a work piece as a route guidance and for an arithmetic conversion of characteristic values that correspond with the reference characteristic into control signals, the method comprising:
detecting a default trajectory for the machine tool by the characteristic values;
reading in the default trajectory; and
providing a working line for a working tool to be driven along and that corresponds with the default trajectory by control signals that correspond with the characteristic values.

2. A method of operating a machine tool comprising a sensory tool for a sensory detection of reference characteristics on a side of a work piece and for an arithmetic conversion of the reference characteristics into characteristic values for control signals, the method comprising:
presenting a trajectory programmed in characteristic values for the machine tool as a route guidance, wherein the control signals that correspond with the characteristic values provide a working line for the working tool that has to be driven along and that corresponds with the trajectory.

3. The method of claim 2, further comprising detecting an advance speed along the working line with sensors, wherein a working speed of working tool is adjusted adaptively to the advance speed.

4. The method of claim 3, further comprising adjusting the working speed by at least one of: a change of a number of strokes; and a rotational speed of the working tool.

5. A method of operating a handheld machine tool comprising a working tool and sensory tools for a sensory detection of reference characteristics visible on a side of a work piece as characteristic values and for an arithmetic conversion of the characteristic values into control signals, the method comprising:
detecting the reference characteristics on the side of the work piece in an area of a starting point;
determining a position of the machine tool to the work piece related to a reference position that is provided by the reference characteristics and by a display of the position of the machine tool to the reference position;
displaying a working line to be driven along; and
controlling the working tool that is oriented towards the working line.

6. The method of claim 5, further comprising, with an oriented direction on the side of the user of the machine tool related to a desired working direction, detecting the reference characteristics on the side of the work piece in the area of the starting point on the side of the work piece;
detecting the position of the machine tool to the reference characteristic;
detecting the position of the working line that has to be driven along to the reference characteristic in the area of the starting point;
determining an advance direction of the machine tool that is oriented towards the working line; and
displaying the advance direction of the machine tool.

7. The method of claim 5, further comprising, with an oriented direction on the side of the user of the machine tool related to a desired working direction,
detecting the starting point of the working tool of the machine tool on the side of the work piece;
detecting the reference characteristics on the side of the work piece in the area of the starting point;
detecting the position of the machine tool to the reference characteristics;
detecting the position of the working line that has to be driven along to the reference characteristics in the starting point;
determining the orientation of the machine tool in the starting point that corresponds with the orientation of working line; and
controlling the working tool corresponding with the determined orientation.

8. The method of claim 5, wherein the working line is a default working line on the side of the work piece.

9. The method of claim 5, wherein the working line is a default working line on the side of the machine tool.

10. A handheld machine tool, comprising:
a working area for a working tool to be positioned at a work piece;
one or more optical tools for a sensory detection of reference characteristics that are provided on a side of the work piece; and
an arithmetic unit and a control unit that are configured for:
processing characteristics values that correspond with the reference characteristics,
compensating the characteristic values with values that describe a programmed default trajectory, and
creating control signals for operation of the machine tool with an orientation of the working tool towards a working line to be driven along and that corresponds with the default trajectory.

11. The handheld machine tool of claim 10, further comprising a signal-beamer that illustrates the working line.

12. The handheld machine tool of claim 10, wherein the one or more tools for the sensory detection are created by a camera.

13. The handheld machine tool of claim 10, wherein the one or more tools for the sensory detection are created by mouse sensors that are arranged in working direction moved up towards the working tool and pointed towards the work piece.

14. The handheld machine tool claim 10, wherein the machine tool is a jigsaw comprising an adjustable saw blade that is stroke driven and rotatable around a longitudinal axis.

15. The handheld machine tool of claim 14, wherein the saw blade is adjusted by a power-operated rotary drive that is controlled by the control signals.
